(19) United States
(12) Patent Application Publication
(10) Pub. No.: US 2023/0013545 A1
(43) Pub. Date: Jan. 19, 2023

(54) Greedy Forward Search Using A Centrality Measure

(71) Applicant: AT&T Intellectual Property I, L.P., Atlanta, GA (US)

(72) Inventors: Rudolph Mappus, Plano, TX (US); Sajib Barua, Farmers Branch, TX (US); Xiaojie Lan, Plano, TX (US)

(21) Appl. No.: 17/367,970

(22) Filed: Jul. 6, 2021

(51) Int. Cl. G06Q 10/08; G06F 16/29; G06F 16/2457

(52) U.S. Cl. CPC G06Q 10/087; G06F 16/29; G06Q 10/083; G06F 16/24578

(57) ABSTRACT

Methods, systems, and apparatuses may provide for receiving an indication of a set of sites in a geographical area, wherein the set of sites comprises a plurality of spare distribution sites; receiving an indication of a respective physical routing distance of each site of the geographical area; and determining a centrality value for each respective site of the plurality of candidate distribution sites of the geographic area, wherein the centrality value is based on the respective physical routing distance of each site of the geographical area.

### BACKGROUND

Network service providers operations teams manage a large inventory of equipment that constitute the network like routers, multiplexers, switches, or hubs. These equipment carry and route the customer data. If the equipment fails, customer services may be affected. For equipment that is deemed critical to providing services, operations teams maintain an on-hand set of spare equipment that is used to restore services when equipment fails. Traditionally, the amount of spares kept are based on equipment failure rates and budget. The presence of spare inventory may help prevent significant downtime from vendor inventory levels, and for that purpose, spares may be housed in centralized supply chain centers. Naively, teams could maintain spare inventory for each in-service item.

Today, legacy equipment no longer manufactured at scale represent a concern for spare inventory management. Significant downtime can result from equipment availability on the open market. A sparing strategy that minimizes risk of downtime while simultaneously minimizing spend for equipment may be critical to supply chain management goals.

This background information is provided to reveal information believed by the applicant to be of possible relevance. No admission is necessarily intended, nor should be construed, that any of the preceding information constitutes prior art.

### SUMMARY

Spare equipment strategies may be significant components to supply chain operations. Being able to maintain spare inventories of equipment for when disasters or outages occur directly affects the time to repair. At the same time, minimizing the costs in spare equipment is a significant supply chain concern. Conventional sparing plans rely on traditional operations research methods that assume a failure level and a base level demand. For this equipment, the failure levels are so low and the demand for them is also so low that the assumptions made in traditional operations research methods break down. The disclosed method addresses these needs while providing computationally tractable sparing plans.

Further, conventionally, centralized distribution centers are used to store spares and are connected to the in-use locations where equipment were operating. Disclosed methods may employ a distributed sparing strategy that aims to place spare equipment at locations closest to locations where equipment are in-use. It simultaneously aims to use a minimal number of spare equipment to cover geographical areas.

The disclosed system or methods disclose an approach for minimizing spare equipment while still minimizing time to repair when failures occur. The disclosed system or methods may use heuristics derived from analyzing a service provider's spare equipment plans and usage. The derived heuristics may produce plans that may be more efficient than conventional supply chain methods.

In an example, an apparatus may include a processor and a memory coupled with the processor that effectuates operations. The operations may include receiving an indication of a set of sites in a geographical area, wherein the set of sites comprises a plurality of spare distribution sites; receiving an indication of a respective physical routing distance of each site of the geographical area; and determining a centrality value for each respective site of the plurality of candidate distribution sites of the geographic area, wherein the centrality value is based on the respective physical routing distance of each site of the geographical area.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates exemplary graph of spare distribution facilities for a geographical area.

FIG. 2 illustrates an exemplary method for greedy forward search selection using centrality measure.

FIG. 3 illustrates an exemplary edge correction scenario.

FIG. 4A is an exemplary illustration of selection of candidates using the disclosed methods.

FIG. 4B is an exemplary illustration of selection of candidates using the disclosed methods.

FIG. 4C is an exemplary illustration of selection of candidates using the disclosed methods.

FIG. 5 illustrates a schematic of an exemplary network device.

FIG. 6 illustrates an exemplary communication system that provides wireless telecommunication services over wireless communication networks.

### DETAILED DESCRIPTION

For efficient distribution of network spare equipment from a central distribution center to local storage locations, the disclosed method helps place spares at locations that minimize retrieval time for nearby in-use locations and use a minimal number of spares to do so. A sparing strategy may require a nondeterministic turing machine to solve in polynomial time.

### Spares Optimization as Set Cover:

Given a superset of locations and a set of subsets of the superset, a minimal cost set of subsets may be determined that cover all locations of the superset. In spares optimization, subsets are the locations where one element includes a spare, and the remaining subset elements depend on that spare (they are locations where the equipment is in service and depends on a spare that is proximate to limit time to repair). A significant factor for time to repair is the time required to fetch the spare. If the spare is at the location, fetch time is 0; if the spare is at another location, fetch time is the driving time (or other travel time) to retrieve the equipment.

In bin packing, there should be assigned as many elements to as minimal number of bins. In spares optimization, the spare equipment would be a bin and the locations that depend on that spare are the elements to assign to a bin.

In both, set cover and bin packing defined by spares, approaches to both issues may require a nondeterministic turing machine to solve in polynomial time. By posing the spares set cover problem as a linear programming problem, it has been shown that set cover problems are dualities of bin packing problems in optimization, and that solutions can be found within a factor of optimal. Being able to solve spares optimization in polynomial time with a deterministic turing machine a set cover or bin packing may be solved which has not been done using conventional methods.

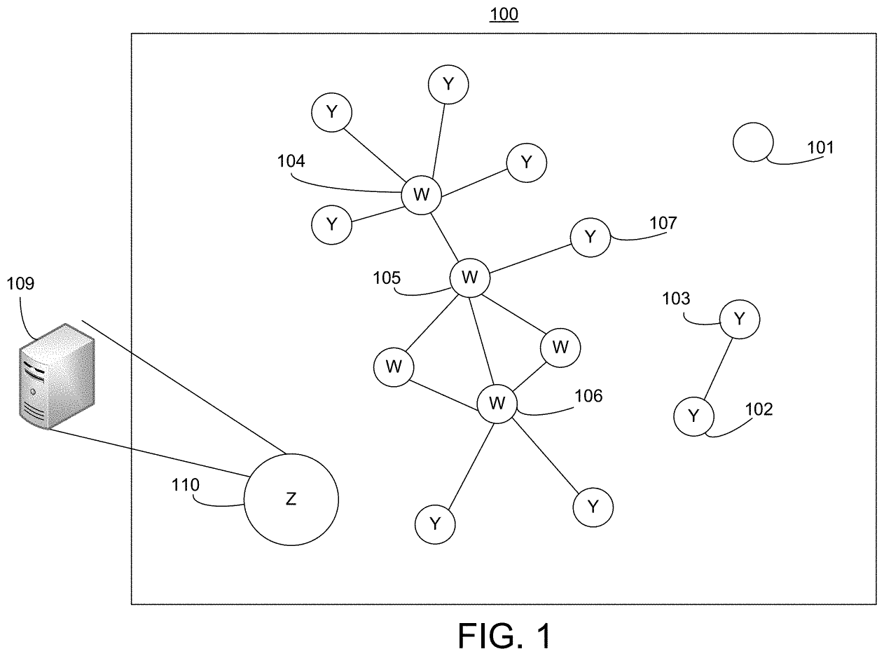

Given a geographical region A (e.g., geographical area 100 of FIG. 1) with a set of N locations and pairwise distances (e.g., routing distance) between them, the disclosed method may help determine a minimal number of spare distribution facilities of the N location from which the rest of the N locations (e.g., nodes or sites) are reachable, which may be based on a given distance threshold. The spare distribution facilities (e.g., sites) may serve as replenishment centers. The disclosed methods may use driving distance (or trail distance if a bike is used for example) between locations rather than straight line distances between locations and may enforce triangle inequality by using the maximum distance between two locations (e.g., the maximum driving distance between (a, b) and (b, a)). Note per spare type should be considered, because the total need and failure rate varies with spare type. However, some types of spares the behave similarly can be grouped and same distribution decision can be applied for individual spare or groups.

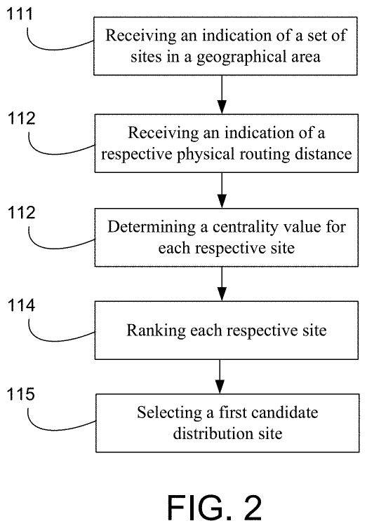

FIG. 1 illustrates an exemplary graph of spare distribution facilities for a geographical area 100. A geographical area graph (also referred to as geographical region herein) is shown in which there is a distant main distribution center, a distant “island” location, and a set of candidate storage locations with in-use locations. Node 110 may be a main distribution facility. The other nodes may be candidate storage locations (also referred to as candidate distribution site), wherein each of them has a resources (e.g., a switch) in use, and some of them will be selected finally for stocking to support others and itself. A spare distribution facility may include warehouses, network central offices, or other sites that may house spare equipment (e.g., routers, switches, or parts thereof). Node 110 may be a distribution facility away from in-use or candidate spare distribution facilities (e.g., node 101, node 102, node 103, node 104, node 105, node 106, or node 107). Node 101 represents an “island” facility. An edge between two locations are those distances below threshold (e.g. 10 mi driving distance). Remaining locations represent optimization candidates. In an example, node 101 (e.g., an “island” facility) may mainly depend on node 110 (main center) for spares. Y nodes (e.g., node 107) may depend on a W node (e.g., node 105) or a Y node (e.g., node 102) may depend on a Y node (e.g. node 103) for a spare. Node 110 (e.g., a network operations site) may include server 109. Server 109 may execute the method steps herein (e.g., FIG. 2) and transmit the appropriate instructions. It is contemplated that method step disclosed herein may primarily occur on one device (e.g., server 109) or be distributed across many devices (e.g., devices in each site of geographic area 100).

FIG. 2 illustrates an exemplary method for greedy forward search selection using centrality measure. At step 111, an indication of a set of sites in a geographical area may be received. The geographic area may be defined by government jurisdiction (e.g., city, school district, county, etc.), by a service provider coverage area, region, weather patterns (which may be indicative of outage patterns), outage patterns (e.g., indication of needs for spares or repairs), or network usage, among other things. The set of sites may include a plurality of spare distribution sites. The plurality of spare distribution sites are respective locations in which spare equipment may be stored.

At step 112, a respective physical routing distance between each site of the geographical area (e.g., road or trailway between each site) may be obtained. This distance may be used to determine edges and subsequently centrality values as disclosed herein.

At step 113, a centrality value for each respective site of the plurality of candidate distribution sites of the geographic area may be determined. Centrality measures the clustering likelihood of a location. A location (e.g., node 105) may obtain higher centrality value when it has more neighbors than the number of neighbors observed for a randomly chosen location (e.g., node 107) in a given geographical area.

The example is formalized in terms of a graph. Consider the undirected graph G=(V, E) where V={l}, is a set of locations (e.g., a site) in geographic area 100 and E={e}, is the edge set where e=<lᵢ, lⱼ> when lᵢ and lⱼ and are spatially connected based on a given distance threshold d. A goal is to find V′=<V where the cardinality of V′, |V′|, is minimal and each location l in V′, serves as spare storage location. Ideally, these locations also serve a maximal number of neighbor in-use locations to be covered for replenishment. Intuitively, an l (e.g., node 105) in V′ should have a higher value of centrality than its neighbors (e.g., node 104, node 106, or node 107).

A centrality measurement may identify initial storage locations in a region. Ripley's K-function is the second order moment property of a stationary point process and a K function can be used to determine spatial distributions of sets of locations (e.g. randomness, clustering, or dispersion) at varying distance resolutions.

Unlike the K-function which is a global measure for an area, the proposed centrality measure is a local measure, determining the clustering intensity at individual points. Suppose X is a stationary point process and λ is the intensity of the point process, then the expected number of points of X per unit area. Ripley's K-function is defined as:

K(d)=λ⁻¹E[number of additional points within distance d of a randomly chosen point] (1)

Hence, λK(d) equals the expected number of additional random points within d of a typical random point of X.

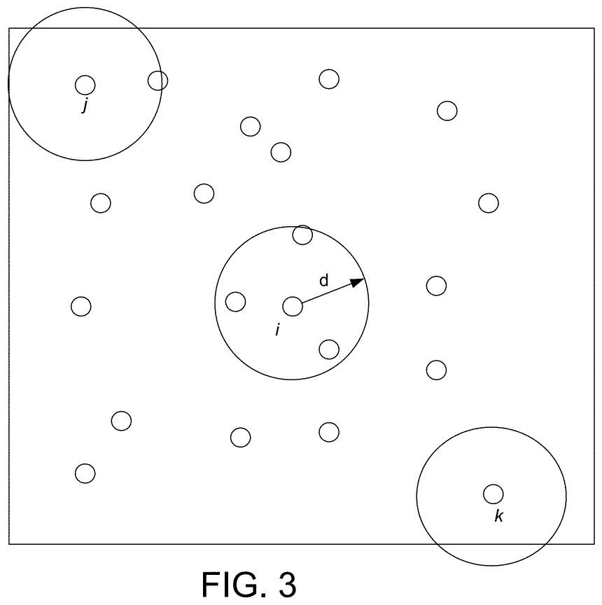

In a geographical region, where locations are randomly distributed, points close to the region border experience fewer additional points within d compared to points who are not at border. This is shown in FIG. 3. To address this, an edge correction is done while computing an estimator of K. The intensity λ\hat{ } can be estimated as λ\hat{ }=N/(Geographic Area (A)), where N is total number of points in A. An estimator of K at d, K\hat{ }(d), with edge-correction is defined as:

$$\hat{K} ( d ) = {\hat{λ}}^{- 1} {\sum }_{i} {\sum }_{j \neq i} {w ( {l}_{i} , {l}_{j} )}^{- 1} \frac{I ( {d}_{ij} < d )}{N} = \vert \frac{A}{N ( N - 1 )} {\sum }_{i} {\sum }_{j \neq i} {w ( {l}_{i} , {l}_{j} )}^{- 1} I ( {d}_{ij} < d ) \qquad ( 2 )$$

w(lᵢ, lⱼ) in Eq. 2 is the proportion of the circular neighborhood (circumference of the circle) with a radius dᵢⱼ that falls in the region. The neighborhood is centered at location lᵢ passing through location lⱼ. I(dᵢⱼ<d) is an indicator function which equals zero if the inter-distance between lᵢ and lⱼ is greater than d, otherwise 1. In FIG. 3, with edge correction the w-value for location j equals 1, whereas for location j and location k, w is less than 1. The method computes each location's centrality by comparing its clustering tendency against the global clustering tendency computed from the whole study area A (e.g., geographical area 100). The centrality measure I_{c} for a point l is defined as:

$$\begin{matrix}{I}_{c} = \frac{\begin{matrix}No of additional points observed around \\ l within distance d\end{matrix}}{\begin{matrix}expected no of additional points observed \\ within distance d of a randomly chosen \\ point from A\end{matrix}} \\ = \frac{\begin{matrix}No of additional points observed around \\ l within distance d\end{matrix}}{\hat{λ} \hat{K} ( d )} \\ = \frac{\begin{matrix}N ( No o \vert f additional points observed \\ around l within distance d )\end{matrix}}{{\sum }_{i} {\sum }_{j \neq i} {w ( {l}_{i} , {l}_{j} )}^{- 1} I ( {d}_{ij} < d )}\end{matrix} \qquad ( 3 )$$

At step 114, each respective site of the plurality of candidate distribution sites of the geographic area may be ranked based on the centrality value.

At step 115, a first candidate distribution site is selected based on the rank (e.g., the highest rank). An inventory system may be updated in order for the spares to be appropriately shifted (e.g., shipped) to the a first candidate distribution site. Shipping labels may be automatically prepared and printed for the address of the first candidate distribution site.

With reference to Table 1, at a high level, the disclosed method ranks locations (e.g., sites) in geographic area 100 to determine the intermediate distribution centers using I_{c}. The disclosed method may then use a greedy forward approach for the selection of candidate locations. Algorithm 1 in Table 1 shows exemplary selection criteria of possible scenarios.

TABLE 1
Algorithm 1: Greedy Forward Search
selection using centrality measure

```
Input: V - a set of locations, d - routing distance threshold for
neighborhood computation, and
E - a set of edges between neighboring locations in V
Output: Find V′ =< V where |V′| is minimal and
locations l′ ∈ V′ cover locations l ∈(V-V′)
Init: V = {l}, V = { }
Include all independent location l in V′ and remove from V
while V not equal to { } do
  If two locations l are neighbors of only themselves, include
  either one in V′
and remove both from V,
  Compute I_{c} value for each candidate l in V and rank them in
  decreasing order
of their I_{c}-values
  If more than one candidate l have the same I_{c} -value, for each
  l with the same I_{c}
-value, compute the neighbors {l^{j}} and ΣⱼI_{c}^{l}^{ⱼ} and rank such candidates l in
increasing order of their ΣⱼI_{c}^{l}^{ⱼ} - values
  After ranking all candidates in V using the above rules,
  select the candidate
which is ranked top and include in V′, V′ ← V′ ∪ {l′}
  Find neighbors of l′, {l′ⱼ}
  For each l′ⱼ do
    If l′ⱼ does not have any neighbor with I_{c} -value
    of 1, remove l′ⱼ from V′,
V′ ← V′ ∪ {l′}
  end
  Remove l′ from V′, V′ ← V′ ∪ {l′}
end
return V′
```

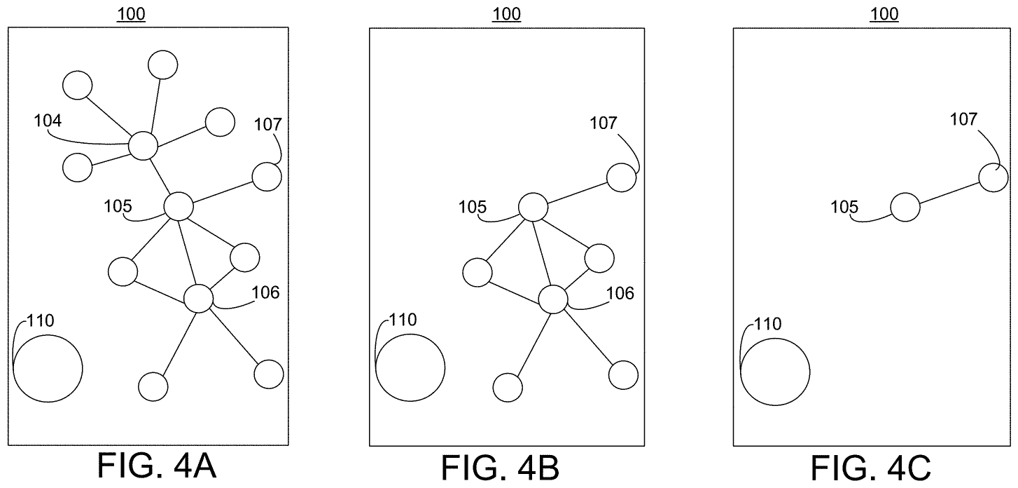

FIG. 4A-FIG. 4C is an exemplary selection of candidates using the disclosed methods (e.g., Algorithm 1). To explain Algorithm 1, the illustration of FIG. 1 is used in conjunction with FIG. 4A-FIG. 4C. First, node 101 in FIG. 1 is selected and removed from V. Then, either of node 102 and node 103 is selected and included in the result. Both are removed from V′. After this, the resultant illustration is shown in FIG. 4A. After re-computing I_{c}-values of remaining locations and ranking them, we find node 104 as top and hence, selected. Node 104 and all its neighbors except node 105 are removed from V′. Node 105 is not removed as it has a neighbor with I_{c}-value of 1. The resultant graph is shown in FIG. 4B. Now between node 105 and node 106, node 106 gets selected. Node 106, along with its all neighbors except node 105 are removed, resulting in the graph shown in FIG. 4C. In FIG. 4C, both location has same I_{c}-value (=1), hence either one can be selected. At the end, V′ includes 1, 4, 6, either 2 or 3, and either 5 or 7. If node 107 were not present, node 105 would have been removed with selection of node 104. The result in that case would be {1, 2, 4, 6} or {1, 3, 4, 6}. IN this example, node 110 is the main distribution center, is not subject to optimization, hence kept is these figures showing snapshot of selection process.

There are multiple types of computation: 1) neighborhood computation and centrality measure computation. In the worst case scenario all n locations are neighbors of each other, forming a clique. Such case will not lead to a solution. However, such scenario is rare. The neighborhood computation is one-time cost (during initialization) which is O(n²). The cost of centrality measure for a location is O(n), where n is the number of neighbors. However, this computation can be efficiently done by maintaining a lookup table on neighbors for each location. After each candidate selection, the graph shrinks, which also reduces the cost of the centrality measure computation.

Being able to generate optimal sparing plans at the scale of the network complexity of large service providers may allow network planners to more efficiently utilize network resources. With regard to solid state equipment, in which failure rates are much lower than traditional equipment stocking methods support, this form of optimization may produce more efficient spare equipment plans. While improving resource utilization have obvious cost benefits, improving network resource utilization also may improve customer experience.

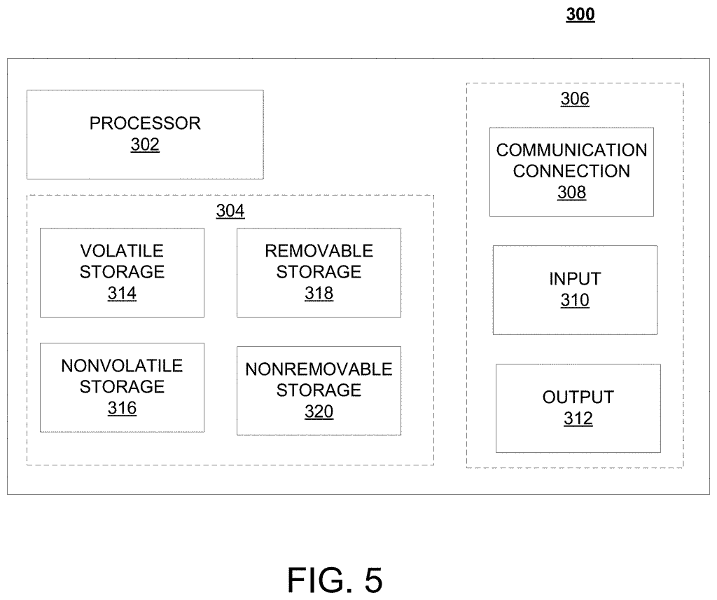

FIG. 5 is a block diagram of network device 300 that may be connected to or comprise a component of a device of FIG. 1 or another system. Network device 300 may comprise hardware or a combination of hardware and software. The functionality to facilitate telecommunications via a telecommunications network may reside in one or combination of network devices 300. Network device 300 depicted in FIG. 5 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 5 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 5) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

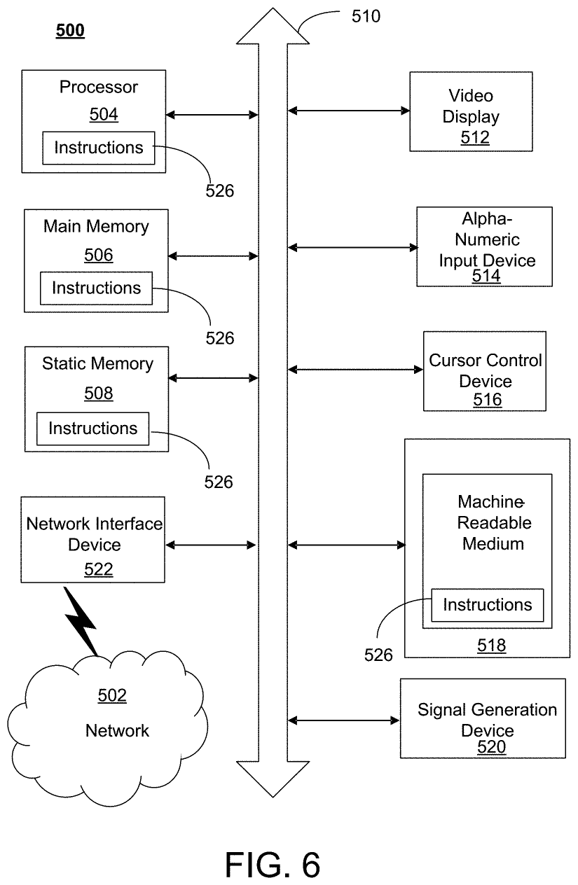

FIG. 6 depicts an exemplary diagrammatic representation of a machine in the form of a computer system 500 within which a set of instructions, when executed, may cause the machine to perform any one or more of the methods described above. One or more instances of the machine can operate, for example, as processor 302, server 109, or other devices disclosed herein. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which greedy forward search selection messages can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—greedy forward search selection using centrality measure—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for greedy forward search selection using centrality measure. A method, system, computer readable storage medium, or apparatus provide for identifying sites in a geographical area, wherein the sites may include a plurality of candidate distribution sites; receiving a centrality value for each site of the plurality of candidate distribution sites; and determining that a first candidate distribution site of the plurality of candidate distribution sites has a highest centrality value of a plurality of respective centrality values of each site of the sites based on the threshold distance. The plurality of respective centrality values of each site of the sites may be determined by comparing the clustering tendency of first candidate distribution site against a global clustering tendency computed from the geographical area. The centrality value may be based on a threshold distance (e.g., 10 miles). All combinations in this paragraph (including the removal or addition of steps) and following paragraph are contemplated in a manner that is consistent with the other portions of the detailed description.

Methods, systems, and apparatuses, among other things, as described herein may provide for receiving an indication of a set of sites in a geographical area, wherein the set of sites comprises a plurality of spare distribution sites; receiving an indication of a respective physical routing distance of each site of the geographical area; and determining a centrality value for each respective site of the plurality of candidate distribution sites of the geographic area, wherein the centrality value is based on the respective physical routing distance of each site of the geographical area. The method, system, computer readable storage medium, or apparatus provides for ranking each respective site of the plurality of candidate distribution sites based on the centrality value. The method, system, computer readable storage medium, or apparatus provides for selecting a first candidate distribution site of the set of sites based on the ranking. The centrality value for each respective site of the plurality of candidate distribution sites of the geographic area may be a clustering likelihood associated with a site. The respective physical routing distance may be the vehicle traveling distance (e.g., roadway or travelable trail distance) between respective sites. The plurality of spare distribution sites are respective locations in which spare equipment may be stored. All combinations in this paragraph (including the removal or addition of steps) are contemplated in a manner that is consistent with the other portions of the detailed description.

What is claimed:

1. A method comprising:
receiving an indication of a set of sites in a geographical area, wherein the set of sites comprises a plurality of spare distribution sites, wherein the plurality of spare distribution sites are respective locations in which spare equipment may be stored;
receiving an indication of a respective physical routing distance of each site of the geographical area;
determining a centrality value for each respective site of the plurality of candidate distribution sites of the geographic area, wherein the centrality value is based on the respective physical routing distance of each site of the geographical area; and
ranking each respective site of the plurality of candidate distribution sites based on the centrality value.

2. The method of claim 1, further comprising selecting a first candidate distribution site of the set of sites based on the ranking.

3. The method of claim 1, further comprising:
selecting a first candidate distribution site of the set of sites based on the ranking; and
in response to the selecting of the first candidate distribution site, providing instructions to reorganize the distribution of spares.

4. The method of claim 1, further comprising:
selecting a first candidate distribution site of the set of sites based on the ranking; and
in response to the selecting of the first candidate distribution site, providing instructions to reorganize the distribution of spares; and
in response to the instructions to reorganize the distribution of spares, preparing shipping labels for the address of the first candidate distribution site from a second candidate distribution site.

5. The method of claim 1, wherein the centrality value for each respective site of the plurality of candidate distribution sites of the geographic area is a clustering likelihood associated with a site.

6. The method of claim 1, wherein the respective physical routing distance is the driving distance between respective sites.

7. The method of claim 1, further comprising updating an inventory system based on the ranking.

8. A system comprising:
one or more processors; and
memory coupled with the one or more processors, the memory storing executable instructions that when executed by one or more processors, cause the one or more processors, to effectuate operations comprising:
receiving an indication of a set of sites in a geographical area, wherein the set of sites comprises a plurality of spare distribution sites, wherein the plurality of spare distribution sites are respective locations in which spare equipment may be stored;
receiving an indication of a respective physical routing distance of each site of the geographical area;
determining a centrality value for each respective site of the plurality of candidate distribution sites of the geographic area, wherein the centrality value is based on the respective physical routing distance of each site of the geographical area; and
ranking each respective site of the plurality of candidate distribution sites based on the centrality value.

9. The system of claim 8, the operations further comprising selecting a first candidate distribution site of the set of sites based on the ranking.

10. The system of claim 8, the operations further comprising:
selecting a first candidate distribution site of the set of sites based on the ranking; and
in response to the selecting of the first candidate distribution site, providing instructions to reorganize the distribution of spares.

11. The system of claim 8, the operations further comprising:
selecting a first candidate distribution site of the set of sites based on the ranking; and
in response to the selecting of the first candidate distribution site, providing instructions to reorganize the distribution of spares; and
in response to the instructions to reorganize the distribution of spares, preparing shipping labels for the address of the first candidate distribution site from a second candidate distribution site.

12. The system of claim 8, wherein the centrality value for each respective site of the plurality of candidate distribution sites of the geographic area is a clustering likelihood associated with a site.

13. The system of claim 8, wherein the respective physical routing distance is the driving distance between respective sites.

14. The system of claim 8, the operations further comprising updating an inventory system based on the ranking.

15. A computer readable storage medium storing computer executable instructions that when executed by a computing device cause said computing device to effectuate operations comprising:
receiving an indication of a set of sites in a geographical area, wherein the set of sites comprises a plurality of spare distribution sites, wherein the plurality of spare distribution sites are respective locations in which spare equipment may be stored;
receiving an indication of a respective physical routing distance of each site of the geographical area;
determining a centrality value for each respective site of the plurality of candidate distribution sites of the geographic area, wherein the centrality value is based on the respective physical routing distance of each site of the geographical area; and
ranking each respective site of the plurality of candidate distribution sites based on the centrality value.

16. The computer readable storage medium of claim 15, the operations further comprising selecting a first candidate distribution site of the set of sites based on the ranking.

17. The computer readable storage medium of claim 15, the operations further comprising:
selecting a first candidate distribution site of the set of sites based on the ranking; and
in response to the selecting of the first candidate distribution site, providing instructions to reorganize the distribution of spares.

18. The computer readable storage medium of claim 15, the operations further comprising:
selecting a first candidate distribution site of the set of sites based on the ranking; and
in response to the selecting of the first candidate distribution site, providing instructions to reorganize the distribution of spares; and
in response to the instructions to reorganize the distribution of spares, preparing shipping labels for the address of the first candidate distribution site from a second candidate distribution site.

19. The computer readable storage medium of claim 15, wherein the centrality value for each respective site of the plurality of candidate distribution sites of the geographic area is a clustering likelihood associated with a site.

20. The computer readable storage medium of claim 15, wherein the respective physical routing distance is the driving distance between respective sites.
